(19) United States
(12) Patent Application Publication
(10) Pub. No.: US 2015/0339950 A1
(43) Pub. Date: Nov. 26, 2015

(54) System and Method for Obtaining Feedback on Spoken Audio

(71) Applicant: Keenan A. Wyrobek, Walnut Creek, CA (US)

(72) Inventor: Keenan A. Wyrobek, Walnut Creek, CA (US)

(21) Appl. No.: 14/720,702

(22) Filed: May 22, 2015

Related U.S. Application Data
(60) Provisional application No. 62/001,684, filed on May 22, 2014.

(51) Int. Cl. G09B 19/06; G09B 7/00

(52) U.S. Cl. CPC G09B 19/06; G09B 7/00

(57) ABSTRACT

A system and method of administering a language learning system. A software application is run that generates a language lesson plan. The language lesson plan presents audible response queries to a user. The software application prompts a user to provide spoken answers to the audible response queries. The software application also enables an evaluator to listen to the spoken answers and assess the accuracy of the spoken answers. The evaluator sends feedback to the first computer device of the user. In this manner, the user can have feedback on how well they answered the audible response query.

### RELATED APPLICATION

This application claims the benefit of U.S. Provisional Patent Application No. 62/001,684, filed May 22, 2014.

### BACKGROUND OF THE INVENTION

1. Field of the Invention

In general, the present invention relates to systems and operating software that enable a person to speak a word or phase and have the accuracy of that spoken word or phrase reviewed by one or more persons at a remote location. More particularly, the present invention relates to systems and methods that provide a speaker with a word or phase to be spoken out loud. The spoken words are received by a microphone and digitally forwarded to another location for review and feedback.

2. Prior Art Description

When learning a language, the proper pronunciations of words and phrases are often the hardest thing to learn. The best way to learn a language is to have access to a person who is fluent in that language. That person can both provide examples of how words and phrases should be pronounced. They can also correct words and phrases that are mispronounced by the person who is learning. However, a person who is fluent in a language and who is willing to help a learner is not always readily available outside of a school. Children who are studying at home often come across words and/or phrases that they do not know how to properly pronounce. If their parents are unavailable, they have few other options. Likewise, adults studying second languages often come across many words and phrases that they do not know how to properly pronounce. If they are studying on their own, they have few other options but to try to find the word or phrase on the Internet.

In modern society, many language learning experiences have been designed into software applications and/or recorded lesson programs. As such, the prior art is replete with recordings and software that show or state a word/phrase and prompt a learner to repeat the stated word or phrase. Although the recording or software may properly pronounce the word or phrase, prior art systems can only assume that the person who is repeating the word or phrase is doing so properly. However, this assumption is often false. A person who merely reads or hears a word or phrase properly pronounced, cannot automatically repeat that word of phrase properly. There are many nuances of language and even slight mispronunciations can alter the meaning of a word or phrase. Furthermore, cadence with the proper positioning of the mouth, lips and tongue needed to pronounce certain words and phrases is a skill that must be repeatedly taught and practiced. Also learners can blend sounds into words incorrectly. Errors made by adding sounds, omitting sounds and getting sounds out of order requires the ear of a person who is fluent in the language.

A need therefore exists for a language learning system that evaluates the manner in which a person pronounces a word or phrase that they are learning. A need also exists for a language learning system where a word or phrase spoken by a person can be evaluated remotely. In this manner a person can effectively practice pronunciation without having to be in the presence of a person who is fluent in the language. These needs are met by the present invention as described and claimed below.

### SUMMARY OF THE INVENTION

The present invention is a system and method of administering a language learning system using a computer network. A software application is provided that has user subroutines, server subroutines and evaluator subroutines. The software application generates a language lesson plan for a user. The language lesson plan produces audible response queries as part of its interaction with the user.

The user subroutines of the software application are run by a user on a first computer device, such as a smart phone. The first computer device communicates with the server through a communications network. The user subroutines of the software application prompt a user to provide spoken answers to the audible response queries.

The evaluator subroutines of the software application are run by an evaluator on a second computer device. The second computer device communicates with the server through the communications network. The evaluator subroutines of the software application enable an evaluator to listen to the spoken answers and assess the accuracy of the spoken answers. The evaluator subroutines enable the evaluator to send feedback to the first computer device of the user. In this manner, the user can have feedback on how well they answered the audible response query.

The feedback is also used to assess the skill level of the user and to update the audible response queries to teach and reinforce language skills. The feedback is also used to assess the evaluation skills of the evaluator.

### BRIEF DESCRIPTION OF THE DRAWINGS

For a better understanding of the present invention, reference is made to the following description of an exemplary embodiment thereof, considered in conjunction with the accompanying drawings, in which:

FIG. 1 is an exemplary schematic of the overall language learning system;

FIG. 2 is a schematic showing the methodology of the user software application being run on a first computer device;

FIG. 3 is a block diagram that outlines the methodology used to evaluate a spoken answer provided by a user;

FIG. 4 is a block diagram schematic showing the methodology used to update lesson plans provided to a user; and

FIG. 5 is a block diagram that illustrates the skill phases used in an exemplary lesson plan.

### DETAILED DESCRIPTION OF THE DRAWINGS

The present invention language learning system can be used by anyone who is learning to read, write and speak a language. As such, it can be used by children who are learning their primary language for the first time, and it can be used by adults who are learning a second language. Although the present invention language learning system can be embodied in many ways, only one exemplary embodiment of the system is illustrated and described. The exemplary embodiment shows the system being configured for a child between the ages of three years and six years. The exemplary embodiment sets forth one of the best modes contemplated for the invention. The illustrated embodiment, however, is merely exemplary and should not be considered a limitation when interpreting the scope of the appended claims.

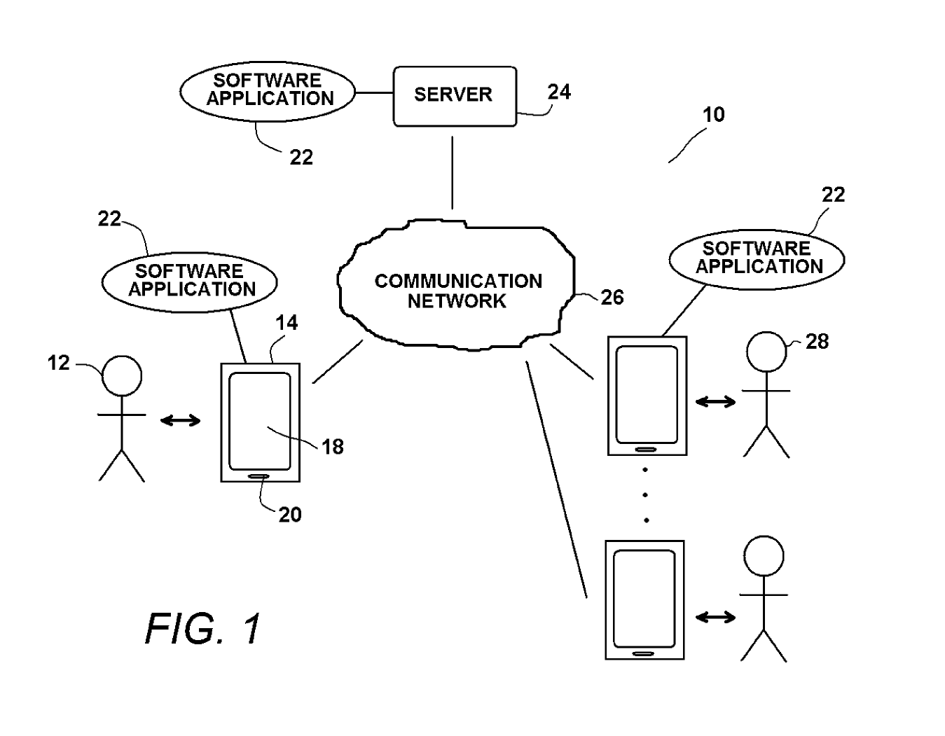

Referring to FIG. 1, the electronic system requirements of the language learning system 10 are described. A user 12, who is learning a language, must have a computer device 14 that is capable of exchanging data though a communications network 16. The computer device 14 can be a PC, a laptop computer, a tablet computer or a specialized unit that is dedicated to the language learning system 10. However, the preferred computer device 14 is a smart phone. As such, a smart phone is illustrated. The computer device 14 has a screen 18 and a microphone 20 as standard equipment.

The computer device 14 is capable of running the user's portion of a software application 22 that is dedicated to the language learning system 10. The computer device 14 is also capable of exchanging data with a remote server 24, via the communications network 16. The communications network 16 can be either a cellular network or a WiFi connection to the World Wide Web. The server 24 runs the corresponding server end of the dedicated software application 22.

The user end of the software application 22 is downloaded onto the computer device 14. In this manner, the computer device 14 can exchange data with the server 24 during operation of the software application 22. The software application 22 is also downloaded into a remote computer device 26 of one or more language lesson evaluators 28. The language lesson evaluators 28 can access the server 24, via the communications network 16. In this manner, the user 12, the server 24 and at least one language lesson evaluator 28 are linked by the running software application 22 that enables these elements to exchange data among one another.

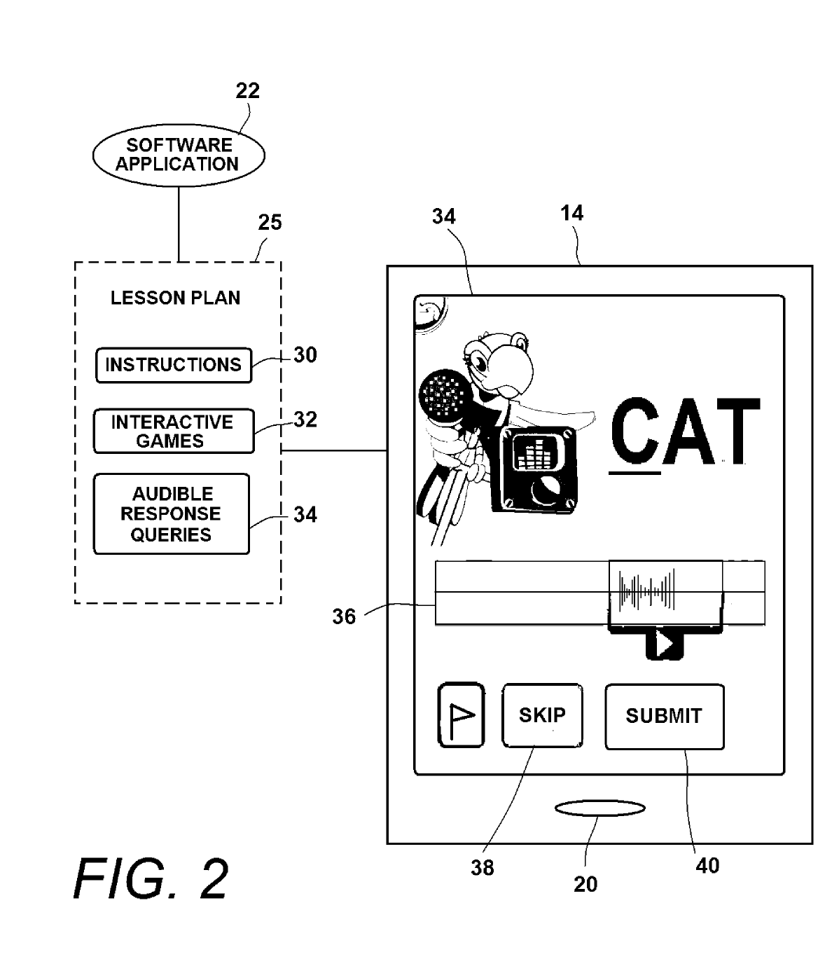

Referring to FIG. 2 in conjunction with FIG. 1, it can be seen at the user's computer device 14, that the software application 22 runs lesson plans 25 that are appropriate for the skill level of the user 12. Details on the skill levels are later presented. The lesson plans 25 include instructions 30, interactive games 32 and/or audible responsive queries 34. The instructions 30 can be presented as text, video and/or animation, depending on the skill level. The interactive games can, likewise, come in many forms. Both the instructions 30 and/or the interactive games 32 are designed to prepare the user 12 to provide a spoken response to an audible response query 34.

In FIG. 2, a screen shot of an exemplary audible response query 34 is shown. The audible response query 34 shown is very basic. It prompts the user 12 to pronounce the word “cat”. This audible response query 34 may have come after an interactive game 32 where the user must make words by combining a letter to the suffix “at”.

In the audible response query 34, the user 12 is given a word or phrase to pronounce. The user 12 is also provided with a start icon and/or an audible prompt, so they can select when to speak an answer to the audible response query 34. The spoken answer is received by the microphone 20 of the computer device 14. The screen of the audible response query 34 may also contain a voice waveform 36 to show the user 12 that a spoken word or phrase was received by the software application 22 through the computer device 14. The screen of the audible response query 34 may also contains a skip icon 38 and a send icon 40. The skip icon 38 is used to reset the spoken answer. The send icon 40 is used to send the spoken answer in for evaluation.

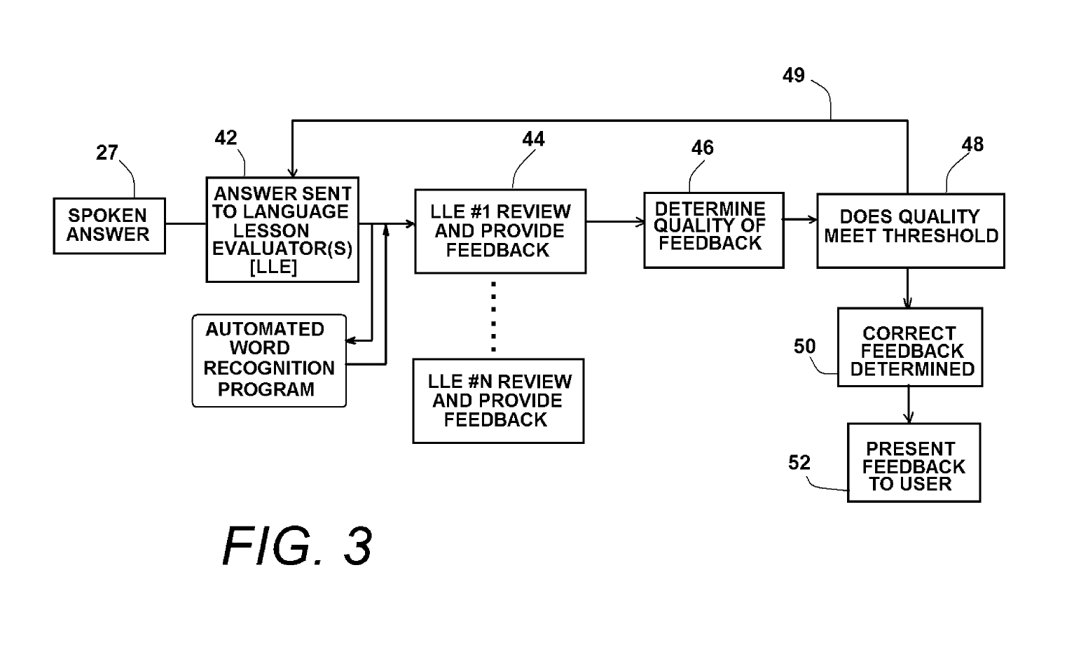

Referring to FIG. 3 in conjunction with FIG. 1 and FIG. 2, it will be understood that the spoken answer 27 submitted by the user 12 is received by the computer device(s) 26 of one or more of the language lesson evaluators 28. The spoken answer 27 may be streamed to the language lesson evaluators 28 in real time. In this synchronous setting, one or more language lesson evaluator 28 will receive the spoken answer only moments after it is transmitted. The language lesson evaluator(s) 28 can then send back a rapid feedback response. Alternatively, the spoken answer 27 can be stored at the server 24, or in a cloud storage cite, until the language lesson evaluators 28 have the opportunity to evaluate the spoken answer 27.

In most situations, the user 12 will be a student and the language lesson evaluator 28 will be an educator. As such, the answer from the educator will be deemed correct. However, in certain other situations, this may not be the case. For example, suppose the language learning system 10 is being used by a person who is learning English as a second language. The language learning system 10 may ask the user to pronounce a word like “pecan” that has different pronunciations depending upon who you ask. Or, a situation may arise wherein the language lesson evaluators 28 is not one fluent person, but rather a pool of other non-fluent people. For example, the answers from one student in a language class may be evaluated by the other students in the same language class.

In the scenario where multiple language lesson evaluators 28 are to be used, subroutines are used by the software application 22 to filter the results. The spoken answer 27 is sent to the queue of a various language lesson evaluators 28. See Block 42 in FIG. 3. The pool of language lesson evaluators 28 individually review the spoken answer 27 and provide feedback. See Block 44. The feedback provided by the language lesson evaluators 28 may be the same or may differ significantly. The quality of the feedback is determined by checking to see if any feedback is the statistically dominant answer, and thus, the answer most likely to be correct. The quality of the feedback must meet a predetermined statistical threshold, such as 3 out of 4 agree. See Block 46 and Block 48. If the quality threshold is not met, the spoken answer 27 is sent to a larger pool of language lesson evaluators 28. See loop line 49. However, if the quality threshold of the feedback is met, the spoken answer 25 is then evaluated in comparison to the presumably correct feedback. See Block 50. The feedback is then sent back to the user 12. See Block 52.

From the above, it will be understood that the spoken answer 27 from a user 12 may be evaluated by a single language lesson evaluator 28 or multiple lesson language evaluators 28. In either case, the language lesson evaluators 28 run the software application 22 on their computer devices 26 and receive the spoken answer 27 from the server 24, via the communications network 16. In the previous description, the language lesson evaluators 28 are people. However, this need not always be the case. The language lesson evaluator 28 can be a separate automated evaluation program that uses word recognition. For simple words and phrases, such as those being used with a young child, a word recognition program can analyze a spoken answer 27 and can provide feedback regarding the accuracy of that spoken answer 27. The word recognition program would be run by the server 24. Audio can be sent to both to a word recognition program(s) and evaluators. For example, a recording could be first sent the word recognition program and if the word recognition program does is not able to process that recording and produce good feedback for what ever reason that recording could then be sent to evaluators.

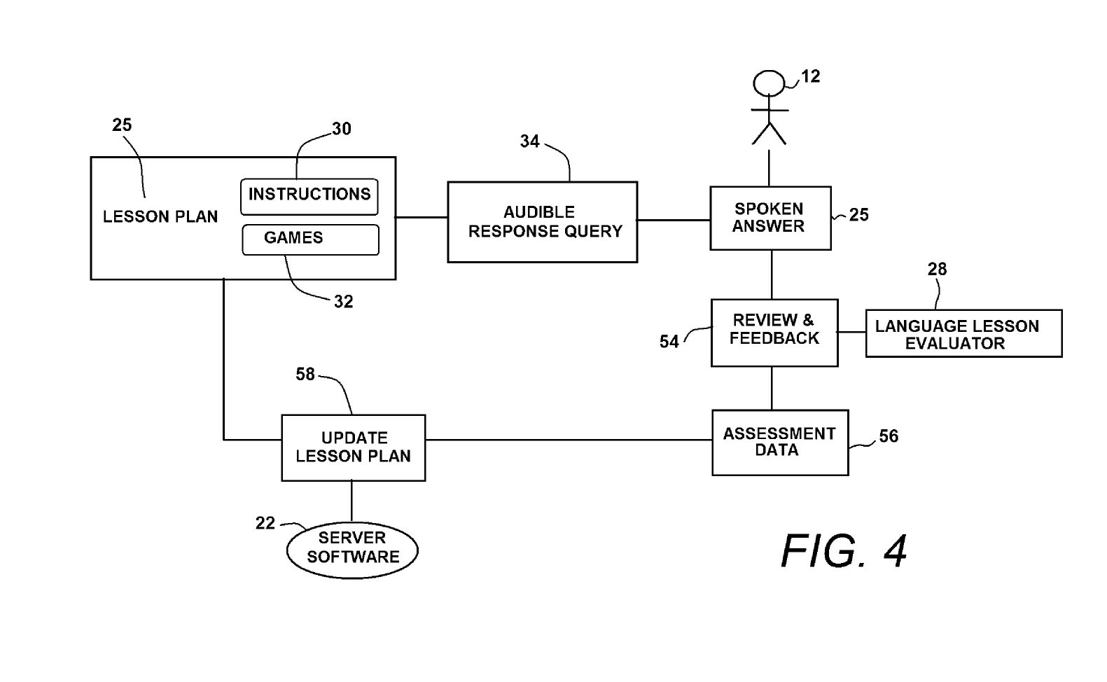

Referring to FIG. 4 in conjunction with FIG. 1 and FIG. 2, it will be understood that the instructions 30 and games 32 produced by the software application 22 that lead to the audible response queries 34 are part of the lesson plan 25. The lesson plan 25 is customized for a particular user 12. Each user 12 starts out with a basic lesson plan that is appropriate for the age and demographics of the user 12. The software application 22 uses instructions 30 and games 32 in accordance with the lesson plan 25. As audible response queries 34 are produced, spoken answers 27 generated by the user 12. The spoken answers 27 are evaluated by the language lesson evaluators 28. See Block 54 in FIG. 4. The language lesson evaluators 28 produce assessment data 56 that is indicative of the skill level of the user. That is, a correct spoken answer to a difficult query would be assessed better than a wrong spoken answer to a simple query. The assessment data 56 is processed by the software application 22 to in order to update the lesson plan 25 for that user. See Block 58.

The user's learning plan 25 is updated after each time a user 12 submits a spoken answer 27 to an audible response query 34. Right and wrong answers produce assessment data 56. The assessment data 56 is saved. New assessment data 56 is processed along with previous assessment data for a user 12 so that a personal skills file for the user 12 can be updated. In this manner, the language learning system 10 has a current understanding of each user's skill level.

Based on the updated skills file, the user's personalized lesson plan 25 is automatically updated with appropriate instruction and reinforcement as needed. This is done by looking to see which skills and skill types have been trigged by the language learning system 10. This produces a prioritized list of skills and skill types that can be presented to the user 12. As a further optimization, the application software 22 monitors how often an activity has been seen by a user 12 so the lesson plan 25 can de-prioritize recently completed activities to improve user engagement. Additionally, the application software 22 can preset a set of activities for the user 12 to choose from, all of which will address needed skills and skill types for that user 12.

The lesson plan 25 is not designed to teach one skill until it is “done,” and then move onto the next skill. Rather, the lesson plan 25 is designed to teach a particular skill over time by moving the user 12 through the teaching phases on a skill-by-skill basis. The number of times that a skill is reviewed or re-introduced in the lesson plan 25 depends on how well the user 12 has mastered each skill.

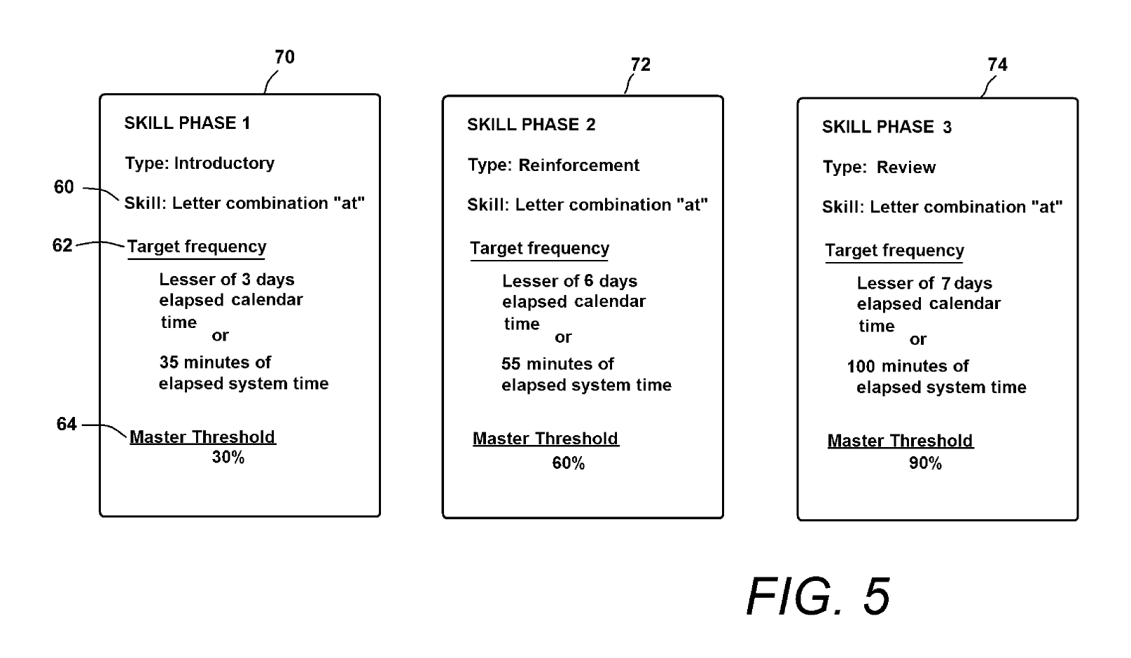

The lesson plan 25 starts with a default teaching and reinforcement strategy for each skill. This default plan can be edited at anytime and even personalized by a teacher for their classroom. Each lesson plan 25 has skill phases. Referring to FIG. 5, an exemplary set of skill phases is shown. With reference to FIG. 5 and the earlier figures, it can be seen that each skill phase has three main technical features. The first technical feature is the skills listing 60. The skills listing 60 is a listing of the skills and skill types that are to be taught in the lesson plan 25. The second technical feature is the target frequency 62. The target frequency 62 is expressed in terms of elapsed system time and elapsed calendar time. The elapsed system time and elapses calendar time measure the periods of time between when a user 12 has refreshed certain skill types using the language learning system 10.

The third technical feature is the use of mastery thresholds 64. Each skill phase has a specific mastery threshold 64. A user 12 can only move from one skill phase into the next by surpassing the mastery threshold 64 for that skill phase. Since the skills of a user 12 are updated each time a user plays on the language learning system 10, dips and rises in the assessment data 56 can be quickly recognized. If the assessment data 56 ever indicates a drop below a certain level for a skill, the user can be moved into the appropriate skill phase for that skill, thereby adjusting the frequency of introductory content or review content for that skill that the user will see. Furthermore, the skill phases can be customized as well and the system 10 can automatically warn or restrict the customizer to prevent skills from being put in any order that would violate any necessary learning order restrictions.

As an example, skill phases for a given skill preferably include an introductory phase 70, a reinforcement phase 72, and a review phase 74. In the introductory phase 70, the user 12 would see a given skill every day that would include a specific mix of skill introduction and review. In the reinforcement phase 72, the user 12 may only see that skill a couple times a week with a different mix of skill introduction and review. In the review phase 74, the user 12 may only see that skill once a week presented only as review. Those time frames can be adjusted by the user 12 and/or by skill and can be expressed in an elapsed system time and/or an elapsed calendar time. This is important since the elapsed system time between when a user 12 sees a skill and that skill is introduced again is not always the best indicator of learning. To illustrate the point, consider a user 12 that does not access the language learning system 10 for a month. It cannot be assumed that such a user would be just as fresh on a skill as a user who used the language learning system 10 just the day before. In this case, the elapsed calendar time is important to ensure that the skill is reviewed as a priority.

The learning plan 25 of each user 12 is personalized. A user's proficiency is constantly updated as each new input of assessment data 56 is produced. From that data, the skills file is generated. Then for every skill that student is progressing toward mastery are put into the right skills phase for that skill. Since the skills phase dictates what skills and skill types and on what frequency in the space of elapsed system and calendar time the system can produce a next activity(ies) that is appropriate for the user 12.

New skills can be phased in many different ways. They can be phased in by looking at where the user 12 is in other phases of previously introduced skills. For example starting a new skill could happen only after the user 12 has moved beyond the first phase of each and all skills for which they are currently in progress. Alternatively, it could wait a certain amount of time after that threshold had been met. Otherwise, it could start a new skill when there are only a certain number of other skills in their first phase.

The language learning system 10 understands calendar time and, like a good teacher, updates a user's lesson based on how long it has been since their last lesson. It also adjusts the level of review/instruction for a skill based on the user's mastery of that skill rather then just stepping back up a list. This is very important since some users can learn to read in months, and for others, it will take years.

The language learning system 10 does not just move a user 12 through a list of skills. After teaching and then testing each skill the language learning system delivers instruction and reinforcement over time in a way that understands skill proficiency as well as both types of elapsed time: elapsed time spent on the system and elapsed calendar time.

It will be understood that the embodiment of the present invention that is illustrated and described is merely exemplary and that a person skilled in the art can make many variations to that embodiment. All such embodiments are intended to be included within the scope of the present invention as defined by the claims.

What is claimed is:

1. A method of administrating a language learning system, comprising the steps of:
providing a software application that generates a language lesson plan for a user, wherein said software application that produces audible response queries, said software application having user subroutines, server subroutines and evaluator subroutines;
running said server subroutines of said software application on a server that is accessible through a communications network;
running said user subroutines of said software application on a first computer device that communicates with said server through said communications network, wherein said user subroutines prompt a user to provide spoken answers to said audible response queries;
running said evaluator subroutines of said software application on a second computer device that communicates with said server through said communications network, wherein said evaluator subroutines enable an evaluator to listen to said spoken answers and assess accuracy of said spoken answers, and wherein said evaluator subroutines enable the evaluator to send feedback to said first computer device of the user.

2. The method according to claim 1, further including the step of analyzing said spoken answers for accuracy and generating assessment data for the user.

3. The method according to claim 2, further including the step of updating said language lesson plan depending upon said assessment data.

4. The method according to claim 1, wherein said spoken answers are streamed from said first computer device to said second computer device in real time, via said communications network and said server.

5. The method according to claim 1, further including the step of recording said spoken answers at a first time to be reviewed by the evaluator at a later second time.

6. The method according to claim 1, wherein said evaluator is an automated word recognition program.

7. A method of administering a language learning system, comprising the steps of:
providing a software application that generates a language lesson plan for a user, wherein said software application that produces audible response queries, said software application having user subroutines, server subroutines and evaluator subroutines;
running said server subroutines of said software application on a server that is accessible through a communications network, wherein said server subroutines generate a language lesson plan for a user that produces audible response queries;
running said user subroutines of a software application on a first computer device that communicates with said server through said communication network, wherein said user subroutines prompt a user to provide spoken answers to said audible response queries;
running said evaluator subroutines of said software application on a plurality of secondary computer devices that communicate with said server through said communication network, wherein said evaluator subroutines enable a selected pool of evaluators to listen to said spoken answers and assess accuracy of said spoken answers, and wherein said evaluator software application enables each of said selected pool of evaluators to produce feedback that assesses the accuracy of said spoken answers;
utilizing said server subroutines of said software application to analyze said feedback from said selected pool of evaluators to determine a correct feedback assessment of said spoken answers;
sending said correct feedback assessment to said first computer device of the user.

8. The method according to claim 7, further including the step of analyzing said spoken answers for accuracy and generating assessment data for the user.

9. The method according to claim 7, wherein at least one of said evaluators is an automated word recognition program.

10. The method according to claim 8, further including the step of updating said language lesson plan depending upon said assessment data.

11. The method according to claim 7, wherein said step of utilizing said server subroutines of said software application to analyze said feedback from said selected pool of evaluators to determine a correct feedback assessment of said spoken answers includes determining if said feedback is gathered from a large enough pool of evaluators to be statistically accurate.

12. The method according to claim 7, wherein said step of utilizing said server subroutines of said software application to analyze said feedback from said selected pool of evaluators to determine a correct feedback assessment of said spoken answers includes determining if said feedback is gathered from a pool of evaluators who are historically sufficiently accurate to be statistically accurate.

13. The method according to claim 11 further including the step of increasing said selected pool of evaluators should said feedback be inaccurate.

14. The method according to claim 11 further including the step of weighting said feedback from each of said selected pool of evaluators based on proficiency.

15. A method of obtaining feedback from others on an audible spoken statement, said method comprising the steps of:
prompting a person to make said audible spoken statement as an answer to a query displayed on a first computer device;
receiving said audible spoken statement when spoken into said first computer device, wherein said first computer device is coupled to a communications network;
forwarding said audible spoken statement to a second computer device via said communications network, wherein said second computer device plays said audible statement to an evaluator who produces an accuracy assessment of said audible spoken statement as said answer to said query;
entering said accuracy assessment of said audible statement into said second computer device, wherein said accuracy assessment of said audible spoken statement is sent back to said first computer device via said communications network.
